(19) United States
(12) Patent Application Publication
(10) Pub. No.: US 2009/0010562 A1
(43) Pub. Date: Jan. 8, 2009

(54) METHOD OF REVISING EDGE REGION AND IMAGE FORMING DEVICE USING THE SAME

(75) Inventor: Woo-jun CHUNG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/970,033

(22) Filed: Jan. 7, 2008

(30) Foreign Application Priority Data
Jul. 3, 2007 (KR) 2007-66580

(51) Int. Cl. H04N 1/405; G06K 9/40

(52) U.S. Cl. 382/266; 358/3.03; 358/1.9; 382/167

(57) ABSTRACT

A method of revising an edge region and an image forming device using the same. The method of revising an edge region includes detecting edge regions from a half-toned image, and adjusting colors with respect to an edge region where a plurality of colors overlap each other among the detected edge regions in accordance with an existence/nonexistence of a black color in the edge region, while adjusting an edge region of a single color with respect to the edge region where the single color exists.

### CROSS-REFERENCE TO RELATED APPLICATIONS

This application claims priority under 35 U.S.C. §119 from Korean Patent Application No. 10-2007-0066580, filed on Jul. 3, 2007, in the Korean Intellectual Property Office, the entire disclosure of which is incorporated herein in its entirety by reference.

### BACKGROUND OF THE INVENTION

1. Field of the Invention

The present general inventive concept relates to a method of revising an edge region and an image forming device using the same. More particularly, the present general inventive concept relates to a method of revising an edge region and an image forming device using the same, to solve a trap phenomenon occurring in an edge region.

2. Description of the Related Art

Generally, an electronic photography system is adopted in an image forming device such as a laser beam printer, an LED print head (LPH), and a facsimile machine. Such an electronic photography type image forming device performs a printing work through processes of charging, writing, developing, transferring, and fusing.

FIG. 1 is a sectional view schematically illustrating a general electronic photography type image forming device.

Referring to FIG. 1, a printing process performed by the electronic photography type image forming device will be briefly described. A yellow optical scanning device 31 scans light onto a photosensitive belt 14 that is circulated by three rollers 11, 12, and 13. A latent image is formed on the photosensitive belt 14 by the scanned light beam, and then is developed by a yellow developer that is supplied from a yellow developing device 21.

In the same manner, respective color optical scanning devices 32, 33, and 34 scan light beams in the order of magenta (M), cyan (C), and black (K), and a color image is formed by developers that are supplied from color developing devices 22, 23, and 24 corresponding to the color optical scanning devices 32, 33, and 34, respectively.

The color image formed on the photosensitive belt 14 is primarily transferred by a transfer roller 51 via a drying device 40, and then the image on the transfer roller 51 is secondarily transferred onto a printing medium through rotation of the transfer roller 51 and a fusing roller 52 to complete the printing operation.

In the electronic photography type image forming device as constructed above, the color optical scanning devices 31, 32, 33, and 34 should be disposed so that spaces between scanning lines, which are emitted from the respective optical scanning devices 31, 32, 33, and 34 and formed on the photosensitive belt 14, accurately coincide with each other.

If the spaces between the respective scanning lines do not coincide accurately with each other, the colors cross each other, and thus a trap (or misregistration) occurs. To solve this problem, a color revision is required.

In order to prevent an occurrence of a trap, a color revision method using position sensors has been generally used. However, the color revision by such a hardwired method using position sensors increases the manufacturing cost of an image forming device.

### SUMMARY OF THE INVENTION

The present general inventive concept provides a method of revising an edge region and an image forming device using the same, which can predict in advance and revise an error occurring in a region where a plurality of colors cross each other by software.

Additional aspects and utilities of the present general inventive concept will be set forth in part in the description which follows and, in part, will be obvious from the description, or may be learned by practice of the general inventive concept.

The foregoing and other aspects and utilities may be achieved by providing a method of revising an edge region including one or more detecting edge regions from a half-toned image, and adjusting one or more colors with respect to an edge region where a plurality of colors overlap each other among the detected edge regions in accordance with an existence/nonexistence of a black color in the edge region, while adjusting an edge region of a single color with respect to the edge region where the single color exists.

The adjusting may include determining whether the black color exists in the edge region where the plurality of colors overlap each other, and emphasizing the black color with respect to the edge region where the plurality of colors overlap each other if it is determined that the black color exists in the edge region, while extending respective color regions existing in the edge region to an outside if it is determined that the black color does not exist in the edge region.

The emphasizing may include emphasizing the black color by removing other colors except for the black color if it is determined that the black color exists in the edge region.

The other colors except for the black color may be magenta and cyan.

The adjusting may include emphasizing the color existing in the edge region where the single color exists.

The foregoing and/or other aspects and utilities of the general inventive concept may also be achieved by providing an edge region classification unit to classify an edge region detected from a half-toned image into an edge region where a plurality of colors overlap each other and an edge region where a single color exists, and a color adjustment unit to adjust the colors with respect to the edge region where the plurality of colors overlap each other in accordance with an existence/nonexistence of a black color in the edge region, and adjusting the edge region of the single color with respect to the edge region where the single color exists.

The color adjustment unit may include a color removing unit to remove other colors except for the black color with respect to the edge region where the plurality of colors overlap each other if it is determined that the black color exists in the edge region; and an edge region extending unit to extend respective color regions existing in the edge region to an outside if it is determined that the black color does not exist in the edge region.

The other colors except for the black color may be magenta and cyan.

The image forming device may further include a black color judgment unit to determine whether the black color exists in the edge region where the plurality of colors overlap each other.

The foregoing and/or other aspects and utilities of the general inventive concept may also be achieved by providing an image forming device, which includes an image processing unit to adjust colors with respect to an edge region where a plurality of colors overlap each other among edge regions of a half-toned image in accordance with an existence/nonexistence of a black color in the edge region, and adjusting an edge region of a single color with respect to the edge region where the singe color exists, and a print engine unit to print the half-toned image in which either of the colors and the edge region has been adjusted.

The image processing unit may remove other colors except for the black color with respect to the edge region where the plurality of colors overlap each other if the black color exists in the edge region, and extend respective color regions existing in the edge region to an outside if the black color does not exist in the edge region.

The image processing unit may emphasize the color existing in the edge region where the single color exists.

The foregoing and/or other aspects and utilities of the general inventive concept may also be achieved by providing an image forming device including a prediction unit to predict an error where a plurality of colors cross each other, and a revising unit to revise the error predicted by the prediction unit by adjusting one or more colors in an edge region where the plurality of colors overlap.

The foregoing and/or other aspects and utilities of the general inventive concept may also be achieved by providing an image forming method including predicting an error where a plurality of colors cross each other, and revising the error predicted by adjusting one or more colors in an edge region where the plurality of colors overlap.

The foregoing and/or other aspects and utilities of the general inventive concept may also be achieved by providing a computer-readable recording medium having embodied thereon a computer program to execute a method, wherein the method includes predicting an error where a plurality of colors cross each other, and revising the error predicted by adjusting one or more colors in an edge region where the plurality of colors overlap.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

The above aspects and utilities of embodiments of the present general inventive concept will become more apparent by describing exemplary embodiments of the present general inventive concept with reference to the accompanying drawings, in which:

FIG. 1 is a sectional view schematically illustrating a general electronic photography type image forming device;

FIG. 2 is a block diagram illustrating an image forming device according to an embodiment of the present general inventive concept;

FIG. 3 is a block diagram illustrating an image forming device according to an embodiment of the present general inventive concept;

FIG. 4 is a block diagram illustrating an image forming device according to an embodiment of the present general inventive concept;

FIGS. 5A and 5B are views illustrating a method of revising an edge region of an image having a composite color;

FIGS. 6A and 6B are views illustrating a method of revising an edge region of an image having a cyan color;

FIGS. 7A and 7B are views illustrating a method of revising an edge region of an image having a magenta color;

FIGS. 8A and 8B are views illustrating a state that an edge region revision has been performed by an image forming device according to the present general inventive concept;

FIG. 9 is a flowchart illustrating a method of revising an edge region according to an embodiment of the present general inventive concept; and

FIG. 10 is a flowchart illustrating a method of revising an edge region according to an embodiment of the present general inventive concept.

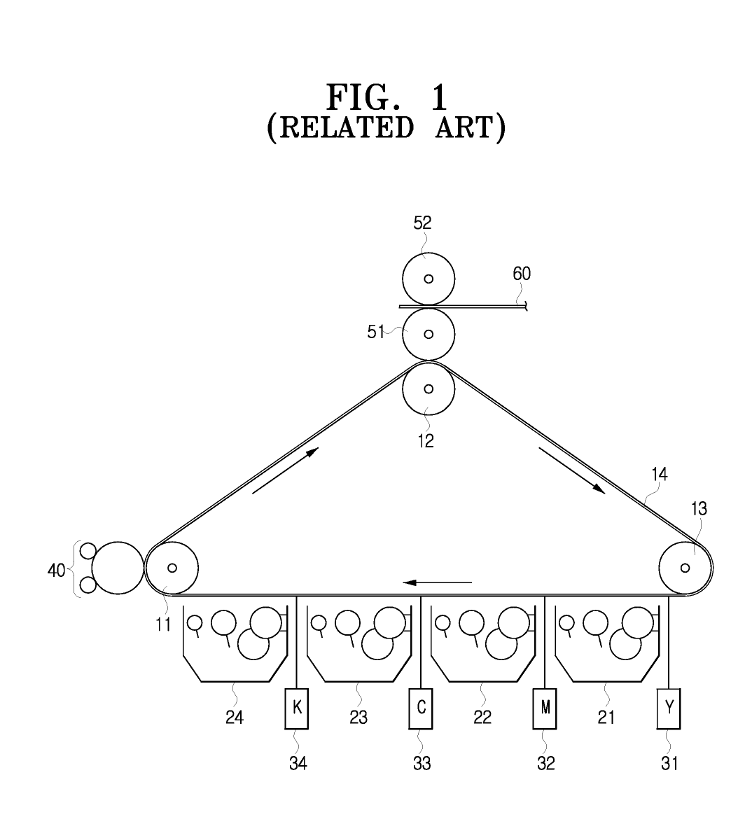

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

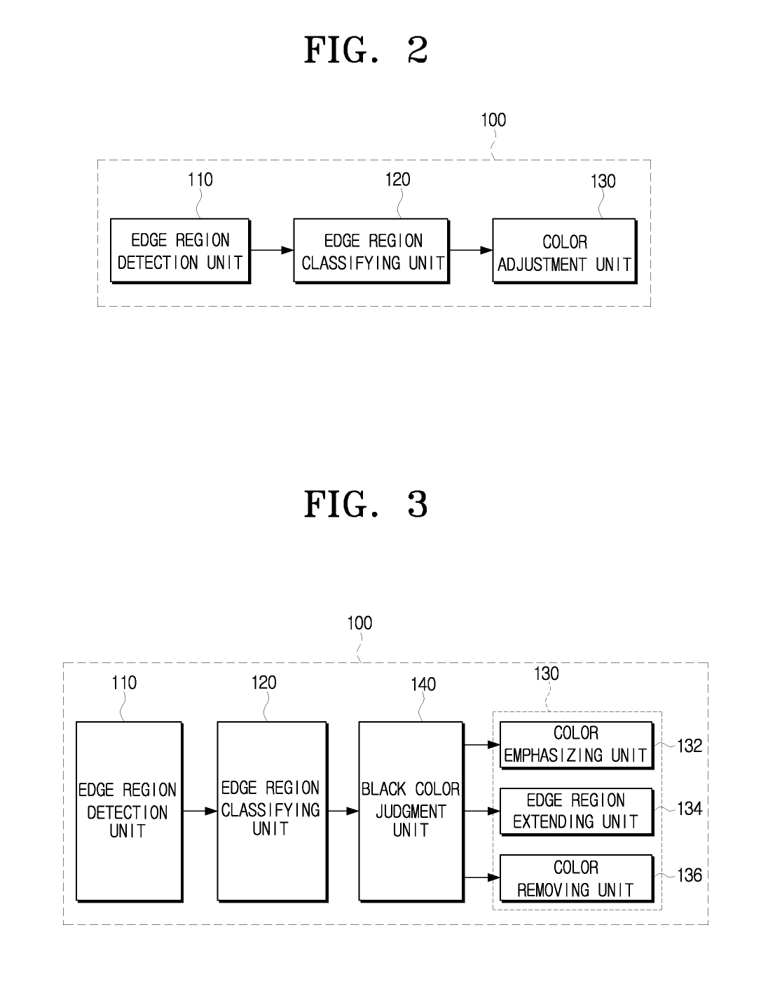

FIG. 2 is a block diagram illustrating an image forming device according to an embodiment of the present general inventive concept.

Referring to FIG. 2, the image forming device 100 according to the present embodiment includes an edge region detection unit 110, an edge region classification unit 120, and a color adjustment unit 130.

The edge region detection unit 110 detects an edge region from a half-toned image. Here, the edge region represents an edge portion of an image that is in contact with another image or a background.

The edge region classification unit 120 classifies the edge region detected by the edge region detection unit 110 into an edge region where a plurality of colors overlap each other and an edge region where a single color exists.

The color adjustment unit 130 adjusts colors with respect to the edge region where the plurality of colors overlap each other in accordance with an existence/nonexistence of a black color in the edge region, and adjusts the edge region of the single color with respect to the edge region where the single color exists.

FIG. 3 is a block diagram illustrating an image forming device according to an embodiment of the present general inventive concept.

Referring to FIG. 3, the image forming device 100 according to the present embodiment includes an edge region detection unit 110, an edge region classification unit 120, a black color judgment unit 140, and a color adjustment unit 130. In the present embodiment, the same reference numerals are given to the same constituent elements as those of the embodiment as illustrated in FIG. 2.

The edge region detection unit 110 detects an edge region from a half-toned image. Here, the edge region represents an edge portion of an image that is in contact with another image or a background. In addition, the half-toned image is a CMYK (Cyan, Magenta, Yellow, and Black) image that is created by converting an RGB type image into a CMYK type image through a color matching and then performing a half toning of the CMYK type image through a printer driver or the image forming device 100.

The edge region classification unit 120 classifies the edge region detected by the edge region detection unit 110 into an edge region where a plurality of colors overlap each other and an edge region where a single color exists.

The black color judgment unit 140 judges whether a black color exists in the edge region where the plurality of colors overlap each other which has been classified by the edge region classification region 120.

The color adjustment unit 130 adjusts colors with respect to the edge region where the plurality of colors overlap each other, which has been classified by the edge region classification region 120, in accordance with the existence/nonexistence of the black color in the edge region, which has been judged by the black color judgment unit 140.

The color adjustment unit 130 adjusts the edge region of the single color with respect to the edge region where the single color exists, which has been classified by the edge region classification region 120.

The color adjustment unit 130 includes a color emphasizing unit 132, an edge region extending unit 134, and a color removing unit 136.

The color emphasizing unit 132 emphasizes the color existing in the edge region where the single color exists. For example, if the single color existing in the edge region is a cyan color, the color emphasizing unit 132 emphasizes the cyan color. Here, the color emphasis represents the same reflection of the half-tone value that corresponds to the edge region.

The edge region extending unit 134 extends respective color regions existing in the edge region where the plurality of colors overlap each other to an outside if it is judged by the black color judgment unit 140 that the black color does not exist in the edge region where the plurality of colors overlap each other. That is, the edge region extending unit 134 extends the cyan color and the magenta color to an outside. Accordingly, a yellow color is excluded from being extended to an outside since the yellow color is not a noticeable color and does not result in emphasis.

The color removing unit 136 removes other colors except for the black color if it is judged that the black color exists in the edge region where the plurality of colors overlap each other. As the color removing unit 136 removes other colors except for the black color, the black color is emphasized.

Accordingly, the yellow color is also excluded from being removed by the color removing unit 136. As a result, other colors except for the black color become the cyan color and the magenta color. That is, the color removing unit 136 removes the cyan color and the magenta color from the corresponding edge region if the black color exists in the edge region where the plurality of colors overlap each other.

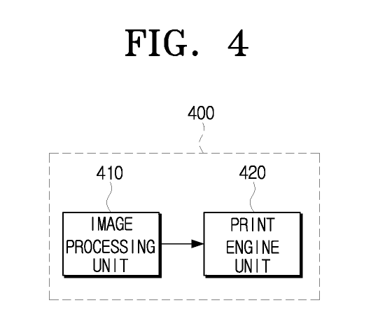

FIG. 4 is a block diagram illustrating an image forming device according to an embodiment of the present general inventive concept.

Referring to FIG. 4, the image forming device 400 according to the present embodiment includes an image processing unit 410 and a print engine unit 420.

The image processing unit 410 adjusts the color with respect to the edge region where the plurality of colors overlap each other among the edge regions of the half-toned image in accordance with an existence/nonexistence of the black color in the edge region, and adjusts the edge region of the single color with respect to the edge region where the singe color exists.

More specifically, the image processing unit 410 removes other colors except for the black color with respect to the edge region where the plurality of colors overlap each other if the black color exists in the edge region, and extends respective color regions existing in the edge region to an outside if the black color does not exist in the edge region. In addition, the image processing unit 410 emphasizes the color existing in the edge region where the single color exists.

The image processing unit 410 performs the same functions as those of the edge region detection unit 110, the edge region classification unit 120, the black color judgment unit 140, and the color adjustment unit 130 illustrated in FIG. 3.

The print engine unit 420 prints the half-toned image in which the edge region has been adjusted by the image processing unit 410.

The image forming devices 100 and 400 as illustrated in FIGS. 2 and 4 may be devices using a PDL (Page Description Language) or a PS (Postscript).

In an exemplary embodiment of the present general inventive concept, the color adjustment unit 130 as illustrated in FIG. 2 or the image forming unit 140 as illustrated in FIG. 4 can be referred to a revising unit. Further, the black color judgment unit 140 or a combination of the black color adjustment unit 140, the edge region detection unit 110 and the edge region classification unit 120 as 9 illustrated in FIG. 2, can be referred to as a prediction unit.

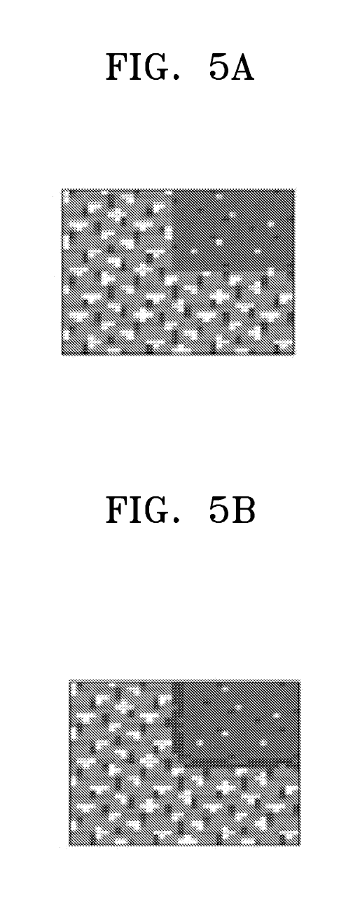

FIGS. 5A and 5B are views illustrating a method of revising an edge region of an image having a composite color.

FIG. 5A illustrates an image in which CMYK colors overlap each other. As illustrated in FIG. 5A, an edge region occurs in a portion where two images cross each other. Accordingly, the edge region is detected by the edge region detection unit 110, and the detected edge region is classified into an edge region where a plurality of colors overlap each other by the edge region classification unit 120.

Then, a revised image as illustrated in FIG. 5B is created by an operation of the edge region extending unit 134 or the color removing unit 136 in accordance with the judgment of an existence/nonexistence of the black color in the edge region through the black color judgment unit 140. FIG. 5B corresponds to the existence of the black color is judged by the black color judgment unit 140 and the black color is emphasized by removing other colors except for the black through the color removing unit 136.

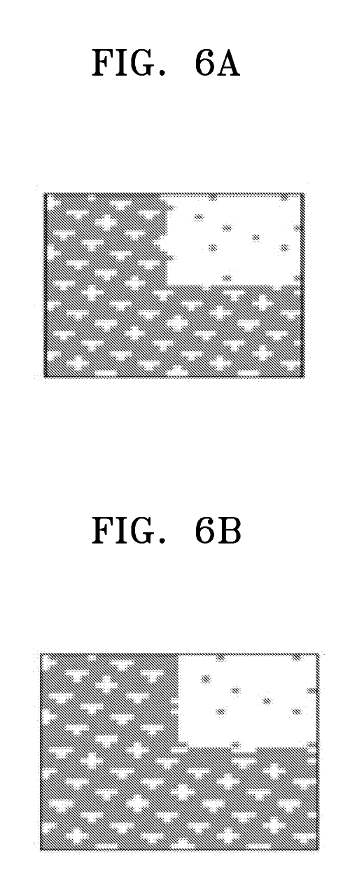

FIGS. 6A and 6B are views illustrating a method of revising an edge region of an image having a cyan color.

FIG. 6A illustrates an image in which the plurality of colors overlap each other, and corresponds to the black color not existing in the edge region as a result of judging the existence/nonexistence of the black color through the black color judgment unit 140. Accordingly, the color existing in the edge region is the cyan color.

As it is judged that the black color does not exist in the edge region of the image as illustrated in FIG. 6A, the edge region extending unit 134 extends the cyan color in a direction of a white region. When the cyan color is extended by the edge region extending unit 134, a result of the revision as illustrated in FIG. 6B can be obtained.

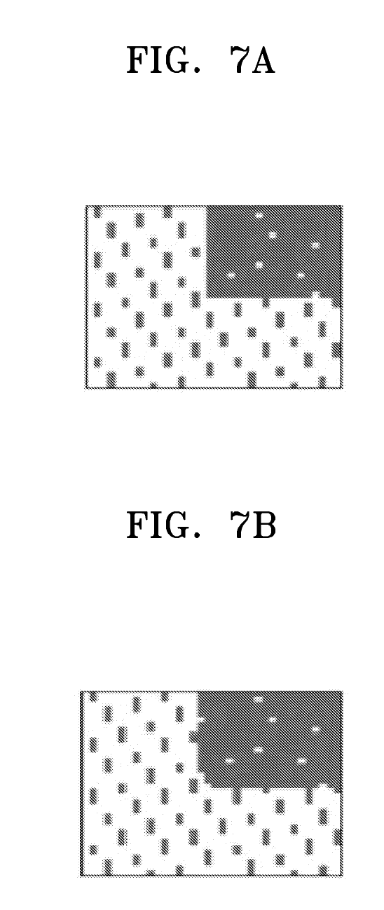

FIGS. 7A and 7B are views illustrating a method of revising an edge region of an image having a magenta color.

FIG. 7A illustrates an image in which the plurality of colors overlap each other, and corresponds to the black color not existing in the edge region as a result of judging the existence/nonexistence of the black color through the black color judgment unit 140. Accordingly, the color existing in the edge region is the magenta color.

As it is judged that the black color does not exist in the edge region of the image as illustrated in FIG. 7A, the edge region extending unit 134 extends the magenta color in a direction of a white region. When the magenta color is extended by the edge region extending unit 134, a result of the revision as illustrated in FIG. 7B can be obtained.

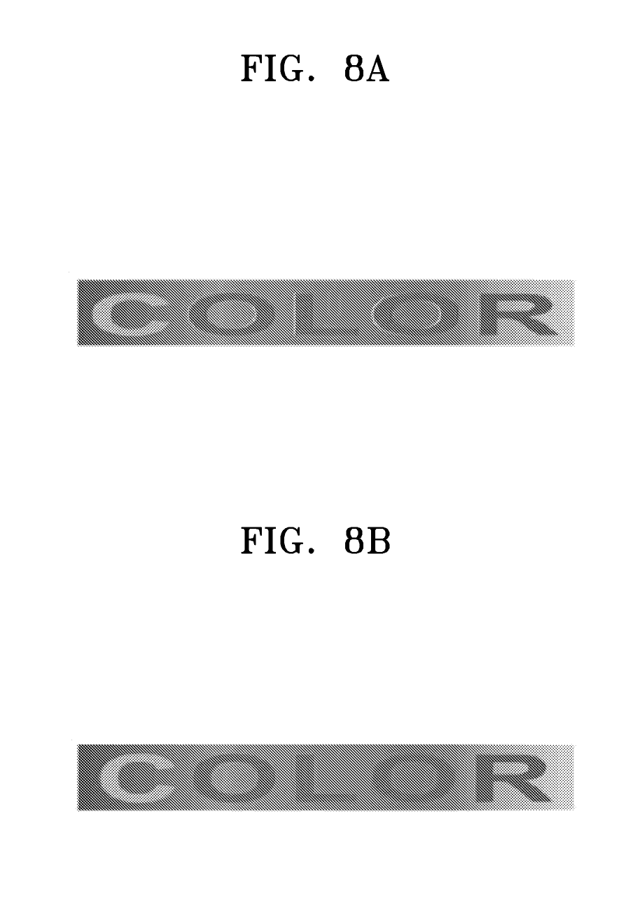

FIGS. 8A and 8B are views illustrating a state that an edge region revision has been performed by an image forming device according to an embodiment of the present general inventive concept.

Referring to FIG. 8A, a trap phenomenon occurs between a text and a background and thus an error occurs in an edge region. Such an error having occurred in the edge region can be revised by the image forming device according to the embodiments of the present general inventive concept. Accordingly, a clear image in which the trap phenomenon between the text and the ground has been revised can be obtained as illustrated in FIG. 8B.

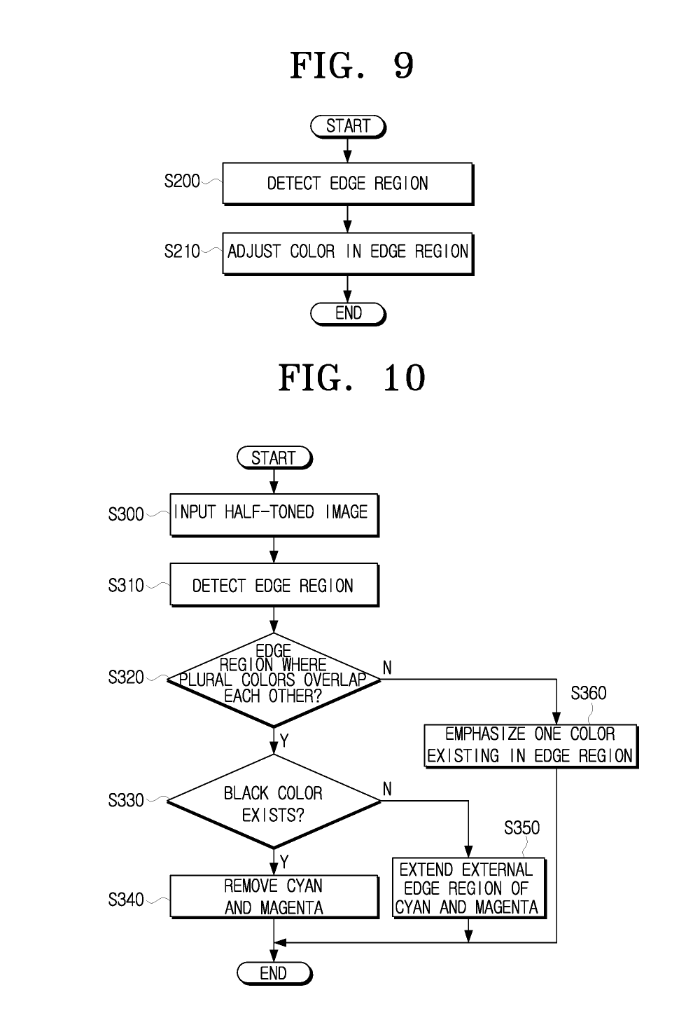

FIG. 9 is a flowchart illustrating a method of revising an edge region according to an embodiment of the present general inventive concept.

The method of revising an edge region according to an embodiment of the present general inventive concept will now be described with reference to FIGS. 2 and 9.

The edge region detection unit 110 detects an edge region from a half-toned image, and the edge region classification unit 120 classifies the detected edge region into an edge region where a plurality of colors overlap each other and an edge region where a single color exists in operation (S200).

The color adjustment unit 130 adjusts colors in accordance with the existence/nonexistence of the black color in the edge region if the edge region to be color-revised by the edge region classification unit 120 is the edge region where the plurality of colors overlap each other, while it adjusts the edge region of the single color if the edge region to be color-revised is the edge region where the single color exists in operation (S210).

FIG. 10 is a flowchart illustrating a method of revising an edge region according to another embodiment of the present general inventive concept.

The method of revising an edge region according to another embodiment of the present general inventive concept will now be described with reference to FIGS. 3 and 10.

When a half-toned image is inputted in operation (S300), the edge region detection unit 110 detects an edge region from the input half-toned image in operation (S310).

The edge region classification unit 120 classifies the edge region detected by the edge region detection unit 110 into an edge region where a plurality of colors overlap each other and an edge region where a single color exists.

If the corresponding edge region is classified into the edge region where the plurality of colors overlap each other by the edge region classifying unit 120 (“Y” in operation (S320)), the black color judgment unit 140 judges whether the black color exists in the corresponding edge region.

If it is judged by the black color judgment unit 140 that the black color exists in the corresponding edge region (“Y” in operation (S330)), the color removing unit 136 removes the cyan color and the magenta color existing in the corresponding edge region in operation (S340).

If it is judged by the black color judgment unit 140 that the black color does not exist in the corresponding edge region (“N” in operation (S330)), the edge region extending unit 134 extends external edge regions of the cyan color and the magenta color in operation (S350).

Alternatively, if the corresponding edge region is classified into the edge region where the single color exists (“N” in operation (S320)), the color emphasizing unit 132 emphasizes the single color existing in the corresponding edge region in operation (S360).

Through the above-described procedure, a trap phenomenon occurring in a region where two images or an image and a background cross each other can be solved.

As described above, according to the method of revising an edge region and the image forming device using the same according to various embodiments of the present general inventive concept, errors by colors occurring due to a mechanical characteristic of the image forming device can be predicted in advance and revised by software without any additional construction. Accordingly, the present general inventive concept can be easily adopted even in an inexpensive image forming device.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents

What is claimed is:

1. A method of revising an edge region, the method comprising:
detecting one or more edge regions from a half-toned image; and
adjusting one or more colors with respect to an edge region where a plurality of colors overlap each other among the detected edge regions in accordance with an existence/nonexistence of a black color in the edge region, while adjusting an edge region of a single color with respect to the edge region where the single color exists.

2. The method of claim 1, wherein the adjusting of the colors comprises:
determining whether the black color exists in the edge region where the plurality of colors overlap each other; and
emphasizing the black color with respect to the edge region where the plurality of colors overlap each other if it is determined that the black color exists in the edge region, while extending respective color regions existing in the edge region to an outside if it is determined that the black color does not exist in the edge region.

3. The method of claim 2, wherein the emphasizing of the black color comprises:
emphasizing the black color by removing other colors except for the black color if it is determined that the black color exists in the edge region.

4. The method of claim 3, wherein the other colors except for the black color comprise:
magenta; and
cyan.

5. The method of claim 1, wherein the adjusting of the colors comprises:
emphasizing the color existing in the edge region where the single color exists.

6. An image forming device, comprising:
an edge region classification unit to classify an edge region detected from a half-toned image into an edge region where a plurality of colors overlap each other and an edge region where a single color exists; and
a color adjustment unit to adjust the colors with respect to the edge region where the plurality of colors overlap each other in accordance with an existence/nonexistence of a black color in the edge region, and adjusting the edge region of the single color with respect to the edge region where the single color exists.

7. The image forming device of claim 6, wherein the color adjustment unit comprises:
a color removing unit to remove other colors except for the black color with respect to the edge region where the plurality of colors overlap each other if it is determined that the black color exists in the edge region; and
an edge region extending unit to extend respective color regions existing in the edge region to an outside if it is determined that the black color does not exist in the edge region.

8. The image forming device of claim 7, wherein the other colors except for the black color comprise:
magenta; and
cyan.

9. The image forming device of claim 6, wherein the color adjustment unit comprises:
a color emphasizing unit to emphasize the color existing in the edge region where the single color exists.

10. The image forming device of claim 6, further comprising:
a black color judgment unit to determine whether the black color exists in the edge region where the plurality of colors overlap each other.

11. An image forming device, comprising:
an image processing unit to adjust colors with respect to an edge region where a plurality of colors overlap each other among edge regions of a half-toned image in accordance with an existence/nonexistence of a black color in the edge region, and adjusting an edge region of a single color with respect to the edge region where the singe color exists; and
a print engine unit to print the half-toned image in which at least one of the colors and the edge region has been adjusted.

12. The image forming device of claim 11, wherein the image processing unit removes other colors except for the black color with respect to the edge region where the plurality of colors overlap each other if the black color exists in the edge region, and extends respective color regions existing in the edge region to an outside if the black color does not exist in the edge region.

13. The image forming device of claim 11, wherein the image processing unit emphasizes the color existing in the edge region where the single color exists.

14. An image forming device, comprising:
a prediction unit to predict an error where a plurality of colors cross each other; and
a revising unit to revise the error predicted by the prediction unit by adjusting one or more colors in an edge region where the plurality of colors overlap.

15. The image forming device of claim 14, wherein the prediction unit is based on whether a black color is present in the edge region.

16. An image forming method, comprising:
predicting an error where a plurality of colors cross each other; and
revising the error predicted by adjusting one or more colors in an edge region where the plurality of colors overlap.

17. A computer-readable recording medium having embodied thereon a computer program to execute a method, wherein the method comprises:
predicting an error where a plurality of colors cross each other; and
revising the error predicted by adjusting one or more colors in an edge region where the plurality of colors overlap.
